(19) United States
(12) Patent Application Publication
(10) Pub. No.: US 2025/0194462 A1
(43) Pub. Date: Jun. 19, 2025

(54) SIDE DISCHARGE CHUTE APPARATUS FOR A POWER EQUIPMENT MACHINE

(71) Applicant: MTD PRODUCTS INC, Valley City, OH (US)

(72) Inventors: Daniel S. Zehentbauer, Westlake, OH (US); Anthony A. Harrison, Spencer, OH (US); Christopher M. Wertenberger, Akron, OH (US)

(21) Appl. No.: 18/985,422

(22) Filed: Dec. 18, 2024

Related U.S. Application Data
(60) Provisional application No. 63/612,105, filed on Dec. 19, 2023.

(51) Int. Cl. A01D 34/71; A01D 34/69; A01D 101/00

(52) U.S. Cl. CPC A01D 34/71; A01D 34/69; A01D 2101/00

(57) ABSTRACT

A discharge chute for directing clippings and other material away from a mowing apparatus during operation can improve clipping dispersion. An example is a side-discharge chute that directs rearward moving clippings sideways to a left or right of the mowing apparatus. In one or more aspects, the discharge chute can include a set of baffles for dispersing clippings along an outlet surface of the discharge chute into a plurality of flow paths. The set of baffles can occlude direct output from the mowing apparatus, and can comprise one or more rib structures, step structures, protrusion structures, or the like. The set of baffles can achieve a dispersion of the clippings that mitigates clumping along a ground surface and promotes settling of clippings into turf for more aesthetic mowing results.

### CROSS-REFERENCE TO RELATED APPLICATION

The present application for patent claims the benefit of priority to U.S. Provisional Patent Application No. 63/612,105 titled SIDE DISCHARGE CHUTE APPARATUS FOR A POWER EQUIPMENT MACHINE and filed Dec. 19, 2023, and is hereby incorporated by reference herein in its entirety and for all purposes.

### INCORPORATION BY REFERENCE

U.S. application Ser. No. 18/373,712 filed Sep. 27, 2023, and titled MOW DECK AND BAGGING SYSTEM FOR HIGH EFFICIENCY WALK-BEHIND MOWING APPARATUS is hereby incorporated by reference herein in its entirety and for all purposes.

### FIELD OF DISCLOSURE

This application relates generally to a power equipment machine, and more specifically to a side discharge chute apparatus for the power equipment machine.

### BACKGROUND

A walk-behind mowing machine generally includes a blade apparatus driven in motion by a power source and contained within a rigid housing. In response to the motion driven by the power source, the blade apparatus cuts a portion of vegetation having a height that exceeds a height-above-ground of the blade apparatus as contained within the rigid housing. The cutting produces vegetation clippings that are propelled by the blade apparatus, or propelled by airflow within the housing generated from the driven motion of the blade apparatus. Handling of the clippings can be conducted in different manners by different mowing machines. A mulching machine can be designed to cut the clippings multiple times, on average, before they disperse to the ground beneath the housing. A bagging machine can direct clippings from the rigid housing into a receptacle to be disposed of by an operator of the mowing machine. Other machines can utilize these or other means for handling clippings, and additional development is expected to advance the handling of vegetation clippings for mowing machines.

### SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Aspects of the present disclosure provide a discharge chute for directing clippings and other material away from the mowing apparatus during operation. The discharge chute can be removable from the mowing apparatus, in various embodiments, to facilitating changing the mowing apparatus from a discharge mode to a mulching mode or a bagging mode, as examples. The discharge chute can be a side-discharge chute that directs rearward moving clippings sideways to a left or right of the mowing apparatus as a particular example. In one or more aspects, the discharge chute can include a set of baffles for dispersing clippings along an outlet surface of the discharge chute into a plurality of flow paths. The set of baffles can occlude direct output from the mowing apparatus, achieving a dispersion of the clippings that mitigates clumping along a ground surface and promotes settling of clippings into turf for more aesthetic mowing results.

In at least one embodiment of the present disclosure, provided is a discharge chute for a mowing apparatus. The discharge chute can comprise a housing defining an inlet and an outlet. The inlet can have an inlet perimeter in fluid communication with at least a portion of a discharge opening of a mow deck of the mowing apparatus, the inlet adapted to receive discharge material from the discharge opening of the mow deck, and the outlet can be adapted to direct the discharge material away from the discharge chute and from the mowing apparatus. Further, the housing can define a surface connecting the inlet with the outlet and directing the discharge material received from the discharge opening of the mow deck into an exit direction that is different from an entrance direction of the discharge material as received at the inlet of the housing from the mow deck. Still further, the discharge chute can comprise a set of baffles protruding downward from a top surface of the housing into an interior volume of the discharge chute, wherein the top surface is adjacent the surface, and wherein the set of baffles is adapted to separate a flow of the discharge material at the outlet into at least a first flow path and a second flow path.

In further embodiments, disclosed is a mowing apparatus. The mowing apparatus can comprise a mow deck defining a housing having an interior space adapted to accommodate motion of a blade apparatus that is secured to the housing and an ejection opening defined within a portion of an interior wall of the housing. Moreover, the mowing apparatus can comprise a discharge body secured to the mow deck and having a chute interior in fluid communication with the ejection opening of the mow deck at a first end of the chute interior. The mowing apparatus can further comprise a discharge chute removably inserted into a second end of the chute interior of the discharge body. The discharge chute can comprise an inlet that receives discharge material exiting the mow deck from the ejection opening, and can comprise an outlet that directs the discharge material away from the mowing apparatus. Moreover, the discharge chute can comprise a set of aerodynamically functional baffles formed within an interior space of the discharge chute near the outlet and adapted to separate a flow of the discharge material into a plurality of flow paths including at least a first flow path and a second flow path.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 provides a drawing of a walk-behind mowing apparatus and side-rear discharge apparatus according to one or more aspects of the disclosed embodiments;

FIG. 2 provides an underside view of the walk-behind mowing apparatus and side-rear discharge apparatus to illustrate additional disclosed aspects;

FIG. 3 illustrates a close-up view of side-rear discharge chute removably secured within a discharge body of a mowing apparatus, in a further aspect;

FIG. 4 is a drawing of a side-rear discharge chute and associated geometry;

FIG. 5 is a drawing of an under side of the side-rear discharge chute of FIG. 4 showing a set of aerodynamically functional baffles, in aspects of the disclosed embodiments;

FIG. 6 shows a perspective view of the under side of the side-rear discharge chute;

FIG. 7 is a close-up view of the perspective view of FIG. 6;

FIG. 8 is an example line drawing of an underside of a disclosed side-rear discharge chute and example baffle dimensioning in another aspect of the disclosure;

FIG. 9 is an example side view of the disclosed side-rear discharge chute and further example baffle dimensioning in additional aspects;

FIG. 10 depicts alternative side-rear discharge chutes according to additional embodiments;

FIG. 11 illustrates a first alternative side-rear discharge chute with a first discharge attachment and defined curvature in a first alternative embodiment;

FIG. 12 illustrates a second alternative side-rear discharge chute with a second discharge attachment and defined curvature in a second alternative embodiment;

FIG. 13 depicts a side-rear diverter with stepped protrusion baffle(s) as alternative (or additional) baffling mechanism;

FIG. 14 illustrates a line drawing of a side view of the first alternative side-rear discharge chute of FIG. 11 with a flow rib(s) in additional embodiments;

FIG. 15 illustrates a line drawing of a side view of the second alternative side-rear discharge chute of FIG. 12 with an alternate flow rib(s) in still further embodiments.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to a high efficiency work housing(s) and discharge components for power equipment machines are described herein, it should be understood that the disclosed machines, components, attachments and the like are not so limited, and modifications may be made without departing from the scope of the present disclosure. The scope of the disclosed power equipment machines, components and attachments are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheel barrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

As utilized herein, relative terms or terms of degree such as approximately, substantially, about, roughly and so forth, are intended to incorporate ranges and variations about a qualified term reasonably encountered by one of ordinary skill in the art in fabricating or compiling the embodiments disclosed herein, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic, e.g., a 0 to five-percent variance or a zero to ten-percent variance from precise mathematically defined value or characteristic, or any suitable value or range there between can define a scope for a disclosed term of degree. As an example, a side-rear discharge diverter 130 for a walk-behind mower 100 can have a length, width or height dimension with a variance of 0 to five-percent or 0 to ten-percent; a disclosed mechanical dimension can have a variance of suitable manufacturing tolerances as would be understood by one of ordinary skill in the art, or a variance of a few to several percent about the disclosed mechanical dimension that would also achieve a stated purpose or function of the disclosed mechanical dimension. These or similar variances can be applicable to other contexts in which a term of degree is utilized herein such as relative position of a disclosed element, angle of incidence of discharge material with respect to a diverter surface, speed of a disclosed motor in rotations per minute (or other suitable metric), accuracy of measurement of a physical effect (e.g., a relative torque output, a relative electric power consumption, a relative motor speed, etc.) or the like.

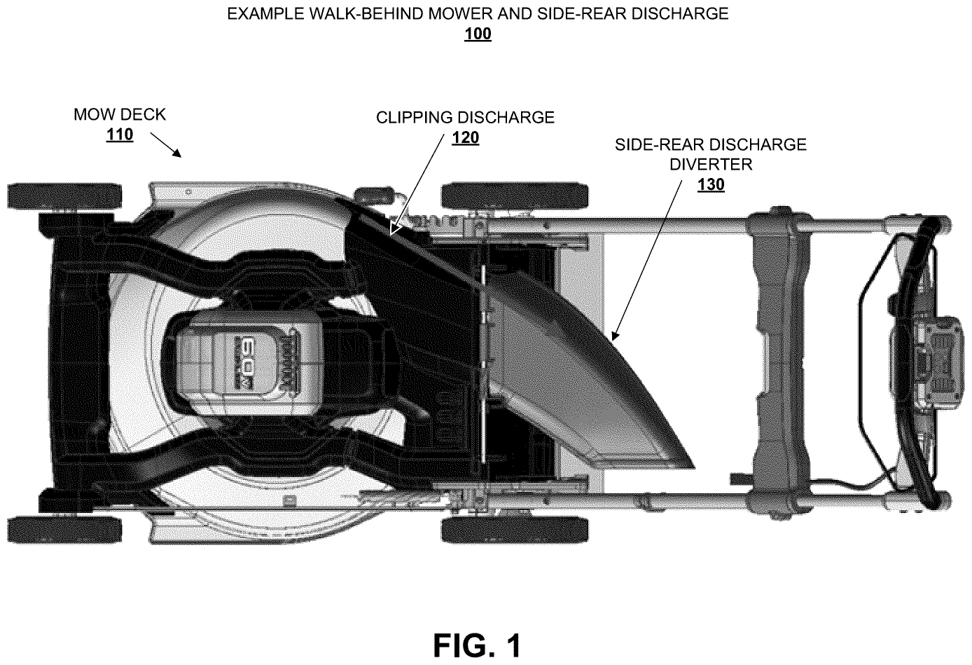

FIG. 1 provides an image of an example walk-behind mower 100 according to aspects of the present disclosure. Walk-behind mower 100 can have a power source to drive an implement of walk-behind mower 100, and in some embodiments to drive rear wheels, front wheels or both the rear wheels and front wheels of walk-behind mower 100. The power source can be an electric motor(s) according to various embodiments (whether battery powered, or powered by an alternating current electric cord, or the like), although the subject disclosure is not so limited and in at least some disclosed embodiments a power source of walk-behind mower 100 can be a combustion engine such as a gasoline engine, a propane engine, a natural gas engine, or the like, or can be a hydraulic engine, pneumatic engine, and so forth. In electric powered embodiments, a power source of walk-behind mower 100 can have one or more electric motors for driving a blade apparatus of walk-behind mower 100, and can optionally drive one or more front or rear wheels to facilitate powered motion of walk-behind mower 100.

A mower deck 110 and frame can provide structural support for a power source (e.g., engine, motor, etc.), electric batteries in an electric powered lawnmower embodiment(s) and the blade apparatus. An underside of mower deck 110 houses one or more blades of a blade apparatus for cutting vegetation under the mower deck 110. Cuttings from the vegetation—also referred to herein as turf clippings—can be discharged from mower deck 110 through a clipping discharge opening 120 (depicted on a right side of a rear portion of mower deck 110 in the illustration of FIG. 1, as viewed from an operator's position behind walk-behind mower 100, but can be located on different positions of mower deck 110 in alternative embodiments—not depicted). In some embodiments, clipping discharge opening 120 can be closed to prevent discharge of turf clippings through the discharge opening, referred to as a mulching operation mode. In the embodiment shown, a side-rear discharge diverter 130 is provided to receive discharge material from mower deck 110 through clipping discharge opening 120 and disperse the discharge material away from walk-behind mower 110 as described throughout this specification.

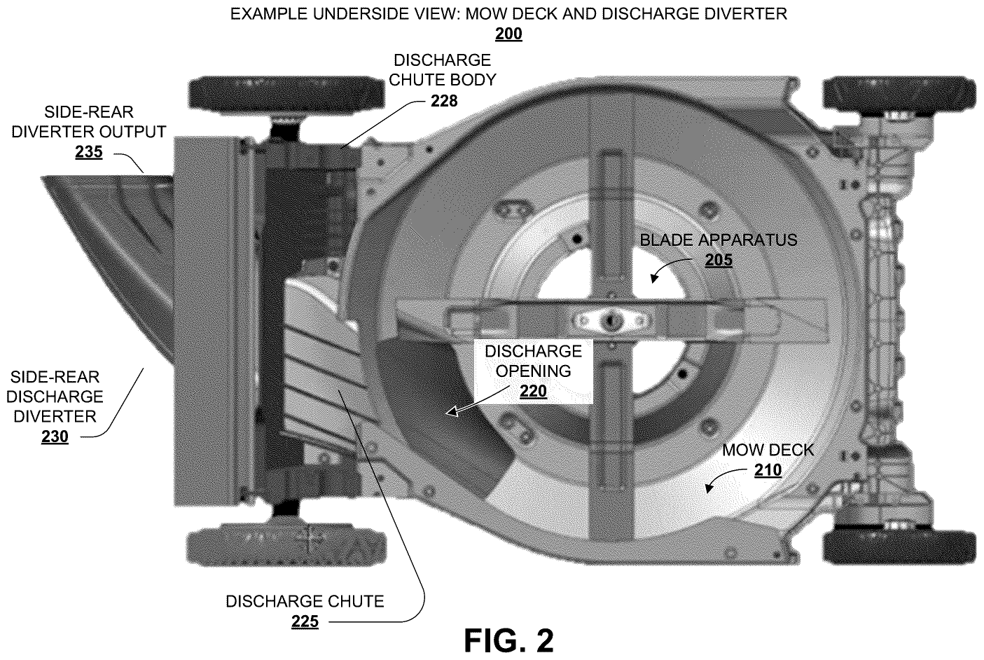

FIG. 2 illustrates an underside view 200 of a mow deck 210 and discharge diverter 230 according to alternative or additional aspects of the disclosed embodiments. Mow deck 210 defines an interior volume in which a blade apparatus 205 is secured and adapted to move in response to mechanical power output by a power source (not depicted). Mow deck 210 defines a discharge opening 220 in an interior surface of mow deck 210. In the embodiments shown in FIG. 2, a discharge chute body 228 is secured to a rear of mow deck 210 and has a discharge chute 225 inlet in fluid communication with discharge opening 220. Discharge material within mow deck 210 generated in response to rotation of blade apparatus 205 can exit mow deck 210 through discharge opening 220 and discharge chute 225.

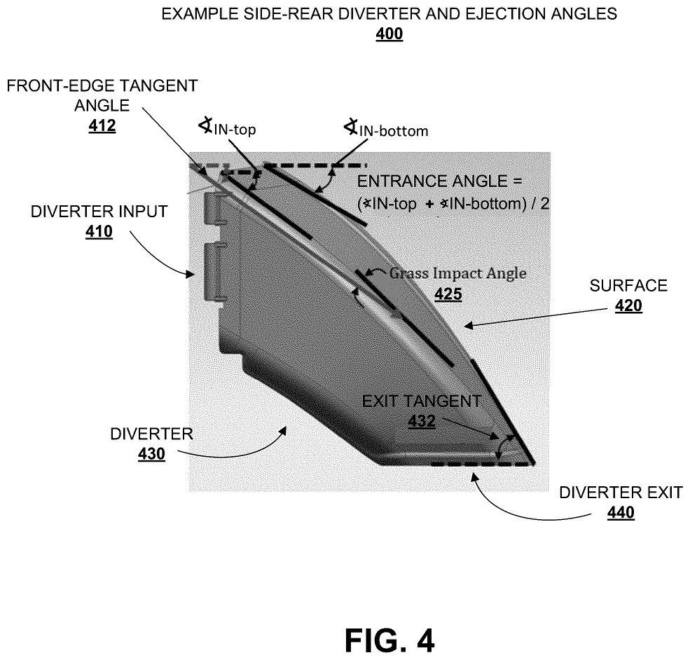

A first portion of a side-rear discharge diverter 230 can be removably positioned within discharge chute body 228. An inlet of side-rear discharge diverter 230 can also be in fluid communication with discharge opening 220. As a result, discharge material entering discharge opening 220 and discharge chute 225 enters side-rear discharge diverter 230 by way of the inlet. Side-rear discharge diverter 230 can redirect a flow of the discharge material to a side-rear diverter output 235 as shown (e.g., see FIG. 4, infra).

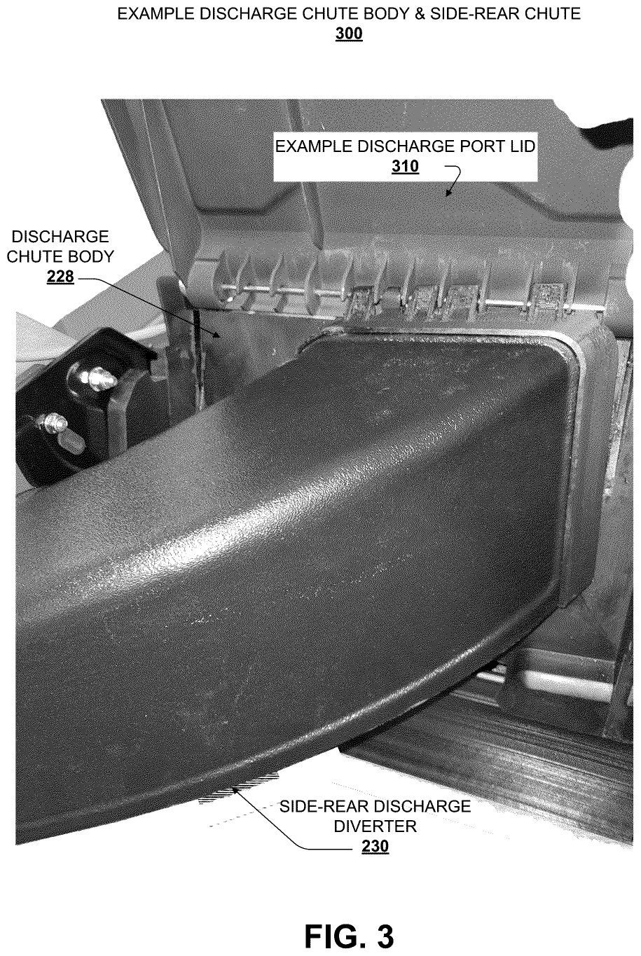

FIG. 3 shows a rear view 300 of a walk-behind mower with a side-rear discharge diverter 230 positioned within a discharge chute opening 235 of discharge chute body 228. Side-rear discharge diverter 230 can have an input geometry (e.g., defining an inlet) shaped to fit snugly (e.g., conformally) within discharge chute 225 so as to remain seated within discharge chute 225 during operation of a walk-behind mower. Accordingly, clippings within mow deck 210 ejected from discharge opening 220 are conveyed through side-rear discharge diverter 230 to a side-rear diverter output 235 thereof.

As shown in FIG. 4, a front-edge tangent angle 412 at a perimeter edge of mow deck 210 defines a right-most edge (as illustrated) for clippings ejected from a walk-behind mower 100 to enter into a side-rear discharge diverter 430. An entrance angle can be defined by an average of a top edge input angle (4N-top) and a bottom edge input angle (4N-bottom). A difference between front-edge tangent angle 412 and the entrance angle can be between about 0 and about 5 degrees, in one or more aspects, or any suitable value or range therebetween. A grass impact angle 425 (e.g., at a back wall of diverter 430) can be defined by front-edge tangent angle 412 and an edge contact point on a surface 420 of diverter 430 that connects diverter input 410 to diverter exit 440 as shown. The grass impact angle can be between 0 degrees and 17 degrees in the illustrated embodiment, though various other grass impact angles are within the scope of the present disclosure, according to relative diverter input 410 orientation and diverter exit 440 orientation, length and width of diverter 430, among other selectable parameters. The exit tangent angle 432 can be between about 45 and about 60 degrees in one or more aspects, or any suitable value or range therebetween.

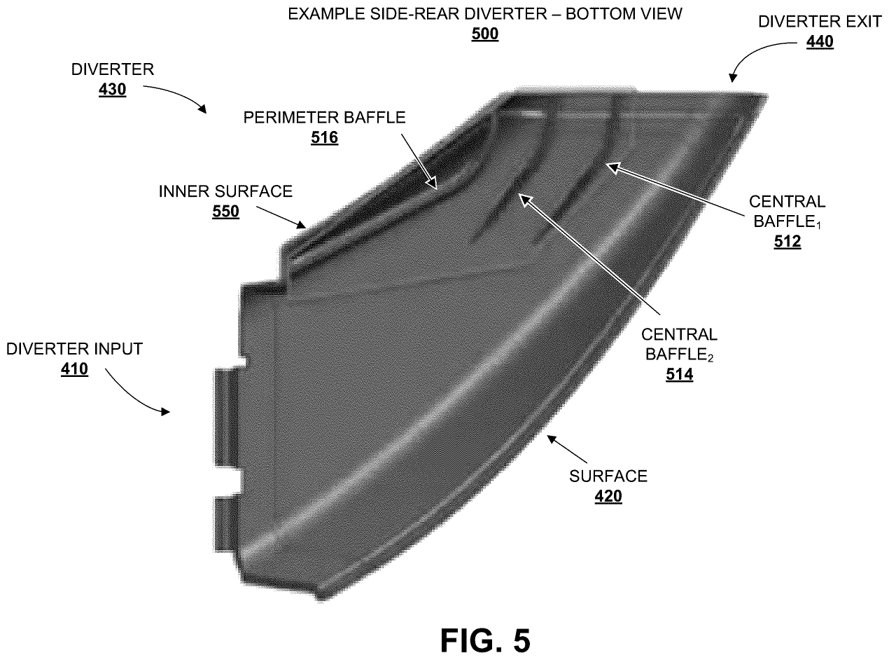

FIG. 5 shows a bottom view 500 of a side-rear diverter 430 according to alternative or additional aspects of the disclosed embodiments. For orientation purposes, diverter input 410 is shown at a left side of bottom view 500 and diverter exit 440 is shown at a top side of bottom view 500. Diverter 430 includes a set of baffles for controlling flow of discharge material received at diverter input 410 and propelled along a length of diver 430 toward diverter exit 440. In the embodiment(s) illustrated by FIG. 5, the set of baffles includes a first central baffle (central baffle₁ 512) and a second central baffle (central baffle₂ 514), referred to hereinafter collectively as central baffles 512-514. Various other aspects of the embodiments can include more central baffles (e.g., three, four, five, etc.) or fewer central baffles (e.g., one) than depicted.

Central baffles 512-514 can be adapted to generate multiple flow paths of discharge material at diverter exit 440. The multiple flow paths can improve distribution of clippings along a width of diverter exit 440, in some embodiments. For instance, a direct exit path from diverter input 410 to diverter exit 440 can be interrupted by the set of baffles and effectively distribute turf clippings out a larger portion of diverter exit 440, avoiding clumping and promoting settling of the clippings into and below a turf surface. This can result in a more aesthetic appearance of cut turf in many circumstances.

The set of baffles shown in FIG. 5 can also include a perimeter baffle 516. Perimeter baffle can be positioned along an interior surface 550 that connects diverter input 410 to diverter exit 440 on an opposite side of diverter 430 from surface 420. Perimeter baffle 516 can be shaped to direct clippings and discharge material into a side wall of central baffle₂ 514, as shown. This helps to distribute material along inner surface 550 within a flow path generated by central baffle₂ 514 and inner surface 550.

As stated, the set of baffles can be configured to distribute a flow of discharge material into multiple respective flows of discharge material distributed along a width of diverter exit 440. Where a single central baffle 512-514 is provided the multiple flows of discharge material will generally include two flows of discharge material. For the embodiment illustrated by FIG. 5, the multiple flows of discharge material will include at least three flows of discharge material (e.g., a first flow between central baffle₁ 512 and surface 420, a second flow between central baffle₂ 514 and central baffle₁ 512 and a third flow between perimeter baffle 516 and central baffle₂ 514). In some embodiments, a largest volume of discharge material can be provided between surface 420 and central baffle₁ 512, but this can be changed in other embodiments by increasing the number of central baffles 512-514, introducing more baffles between central baffle₁ 512 and surface 420, or the like, as desired.

In further embodiments, central baffle₂ 514 can be positioned a first distance from inner surface 550. Central baffle₁ 512 can be positioned a second distance from inner surface 550. Further, the first distance can be larger than the second distance. In some embodiments, the first distance can be less than half a width of diverter exit 440 (e.g., a distance between inner surface 550 and surface 420 along diverter exit 440). In other embodiments, the first distance can be approximately half the width of diverter exit 440 (e.g., fifty percent plus or minus 5 percent, plus or minus 10 percent or plus or minus 15 percent, as examples). In additional embodiments, the second distance can be between about one quarter and about one third the width of diverter exit 440.

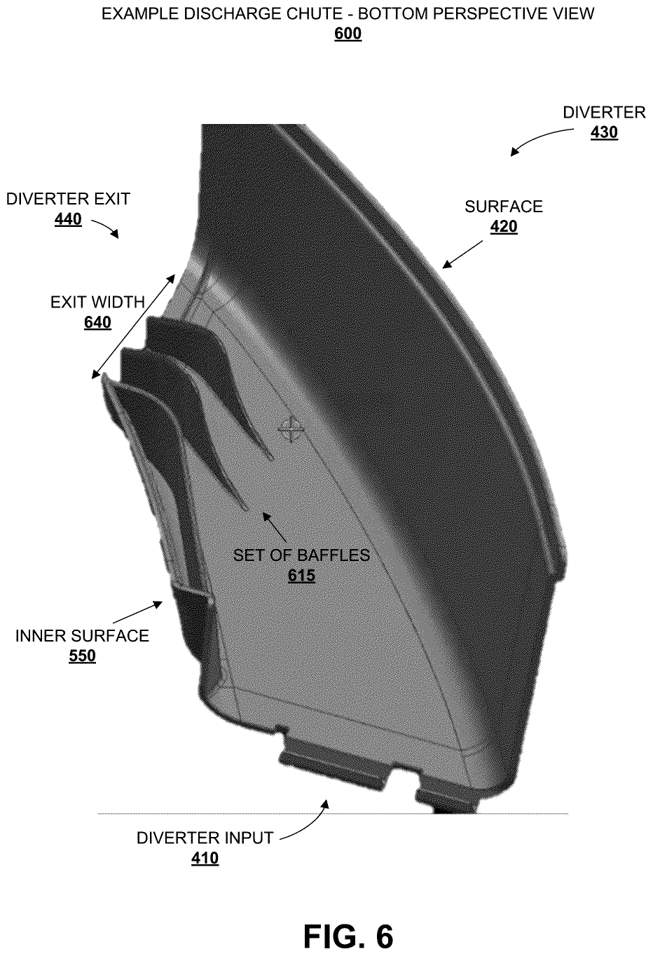

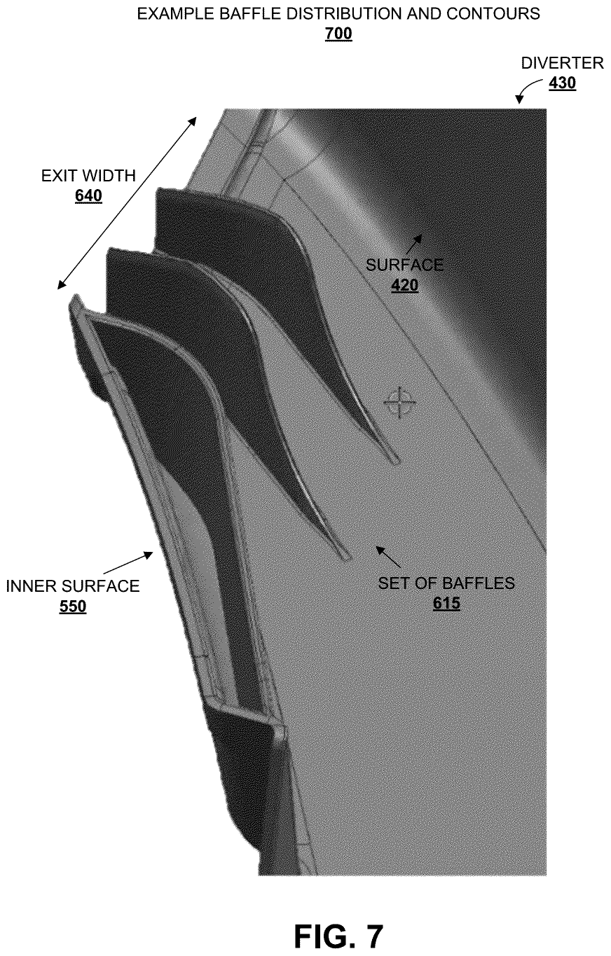

FIGS. 6 and 7 show diverter 430 from a perspective view, allowing a height (or depth) of set of baffles 615 within an interior volume of diverter 430 to be visible. Set of baffles 615 can be configured to collect and direct clippings moving within diverter 430 from diverter input 410 to diverter exit 440 and create multiple flows of clippings out diverter exit 440. Set of baffles 615 can serve to distribute discharge materials across exit width 640 as described herein.

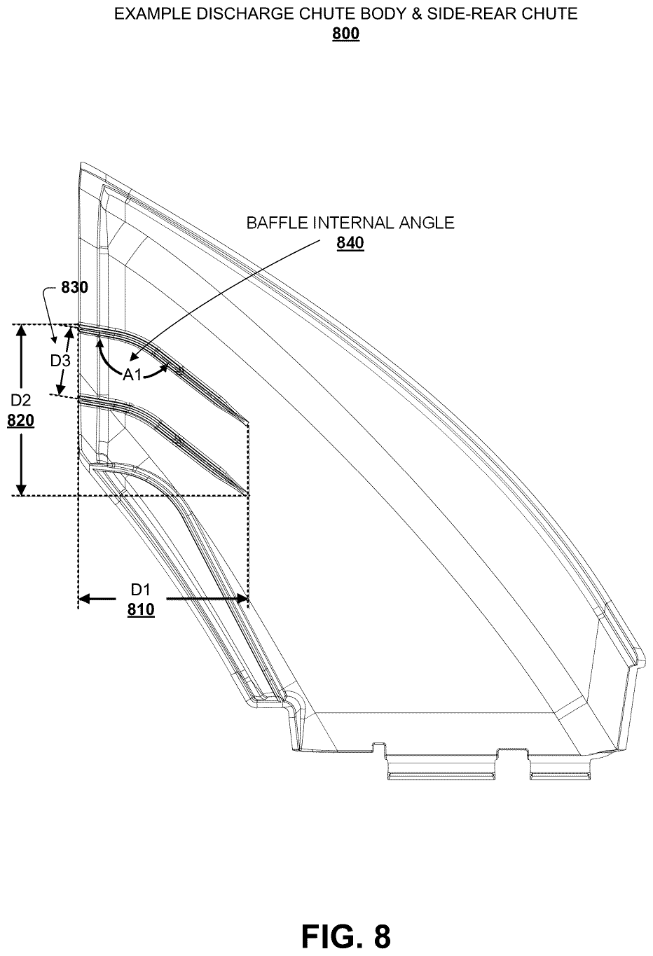

FIG. 8 illustrates a bottom view 800 of an example discharge chute according to still further embodiments of the present disclosure. Bottom view 800 shows several dimensions associated with set of baffles 615, including a first dimension D1 810 indicating a length of central baffles 512-514 from diverter exit 440 into an interior of diverter 430 along a top surface of diverter 430. A second dimension D2 820 represents a lateral extent along exit width 640 of set of baffles 615, and a third dimension D3 830 represents a distance between central baffle₁ 512 and central baffle₂ 514 at a surface of diverter exit 440. In addition, a baffle internal angle 840 shows a curvature of central baffle₁ 512. In various embodiments, D1 810 can be between about 3 and about 4 inches or a suitable value or range there between (e.g., 3.25 inches, 3.35 inches, 3.5 inches, 3.65 inches, 3.75 inches, and so on). Dimension D2 can be between about 3 and about 4 inches or a suitable value or range there between (e.g., 3.5 inches, 3.6 inches, 3.7 inches, 3.8 inches, 3.9 inches, . . . ). Dimension D3 830 can be about 1.25 to about 1.75 inches or a suitable value or range there between (e.g., 1.3 inches, 1.35 inches, 1.4 inches, 1.45 inches, 1.5 inches, 1.55 inches, 1.65 inches, 1.7 inches, etc.). Angle A1 840 can be within a range from about 120 to about 180 degrees or a suitable value or range there between (e.g., 143 degrees, 147 degrees, 151 degrees, 159 degrees, 164 degrees, 172 degrees, and so forth).

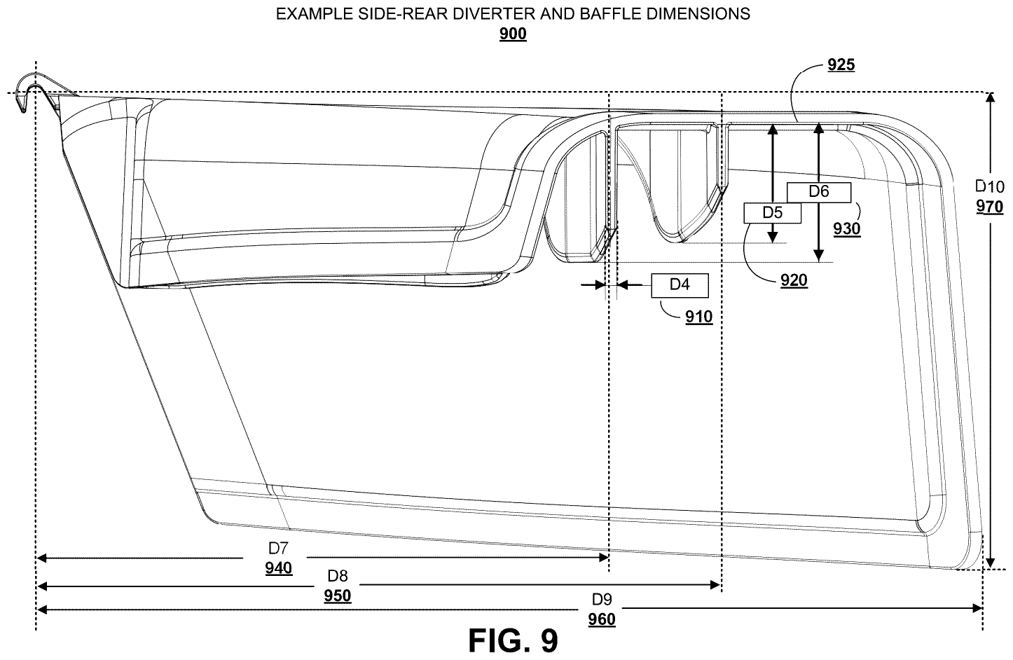

FIG. 9 illustrates a side view 900 of a diverter exit 440 of a side-rear diverter and baffle dimensions thereof according to still further aspects of the disclosed embodiments. Exit side view 900 shows an example thickness dimension D4 910 of set of baffles. Further, an example height dimension D5 920 from central baffle₁ 512 to an interior top surface 925 of diverter 430 is shown. Height dimension D5 920 represents a distance from interior top surface 925 that central baffle₁ 512 extends into an interior volume of diverter 430. Likewise, dimension D6 930 represents a distance from interior top surface 925 that central baffle₂ 514 extends into the interior volume of diverter 430, as shown. Dimension D7 940 represents a distance from central baffle₂ 514 to a front edge of diverter 430 connecting diverter 430 to a discharge body of mowing apparatus (e.g., see FIGS. 1-3, supra). Dimension D8 950 represents a distance from central baffle₁ 512 to the front edge of diverter 430, and dimension D9 960 represents a full length of diverter 430 from a back edge of surface 420 at diverter exit 440 to the front edge of diverter 430, as shown. Moreover, a dimension D10 970 represents a full height of diverter 430 from the back edge (bottom) of surface 420 at diverter exit 440 to a top of the front edge of diverter 430.

In various embodiments, thickness dimension D4 910 can be between about 0.12 and about 0.2 inches or a suitable value or range there between (e.g., 1.4, 1.5, 1.6, 1.7, 1.8 inches, and so on). Height dimension D5 920 can be between about 1.5 and about 1.75 inches or a suitable value or range there between (e.g., 1.525, 1.55, 1.575, 1.625, 1.65, 1.725, etc.). Height dimension D6 930 can be between about 1.75 and about 2.0 inches or a suitable value or range there between (e.g., 1.78, 1.825, 1.84, 1.87, 1.9, 1.95, 1.985, and so on). Distance dimension D7 940 can be between about 7.5 and about 8.0 inches or a suitable value or range there between (e.g., 7.7, 7.8, 7.9 inches, . . . ). Distance dimensions D8 950 can be between about 9.0 and about 10.0 inches or a suitable value or range there between (e.g., 9.2, 9.4, . . . 9.6, 9.8 inches, and so on), and dimension D9 960 can be between about 12.5 and about 13.5 inches or a suitable value or range there between (e.g., 12.6, 12.7, . . . 13.3, 13.4 inches, and so forth). Additionally, distance dimension D10 970 can be between about 6.25 and about 6.75 inches or a suitable value or range there between (e.g., 6.3, 6.4, 6.5, 6.6, 6.7 inches, and the like).

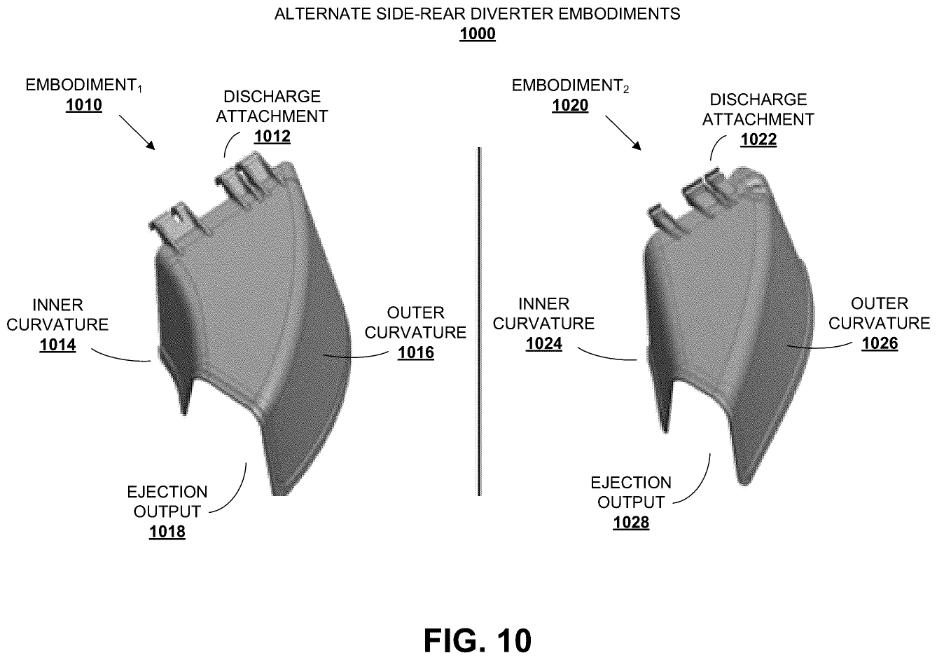

FIG. 10 illustrates alternate side-rear diverters 1000 in still further embodiments of the present disclosure. In some aspects of the disclosed embodiment(s), alternate side-rear diverters 1000 can be configured for walk-behind combustion engine driven mowing devices. However, the subject disclosure is not so limited, and in other aspects alternate side-rear diverters 1000 can be implemented for other walk-behind mowing devices such as electric motor driven mowing devices, hydraulic driven motor devices, pneumatic driven mowing devices, and so on.

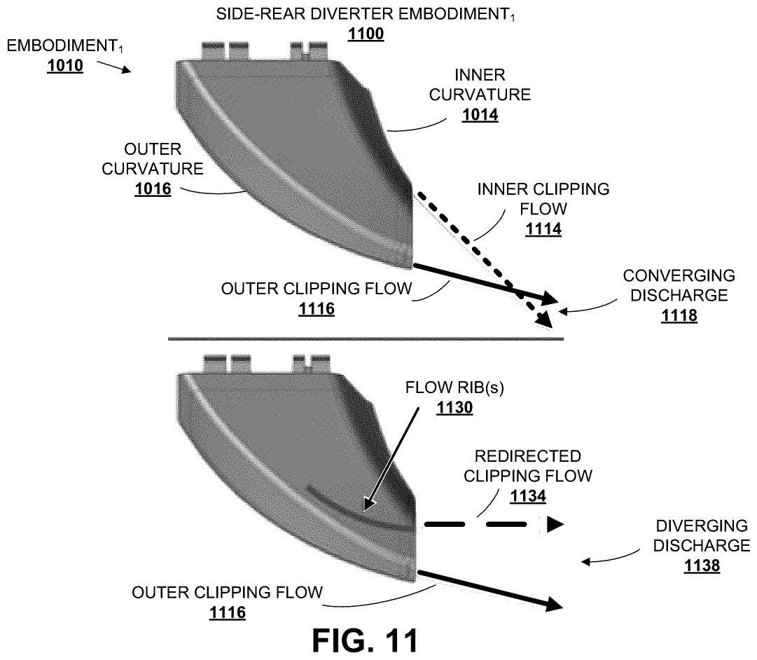

A first embodiment: embodiment₁ 1010 is shown on the left side of FIG. 10 having a first discharge attachment 1012. Further, embodiment₁ 1010 can define an inner curvature 1014 surface and can define an outer curvature 1016 surface which direct clippings ejected from an attached mowing device at an ejection input surface adjacent discharge attachment 1012 to an ejection output 1018 (see also FIG. 11, infra). More specifically, embodiment₁ 1010 can receive clippings ejected (primarily) in a first direction (or range of directions) rearward from the attached mowing device and direct the received clippings into a second direction (or range of directions) sideways and lateral to the attached mowing device.

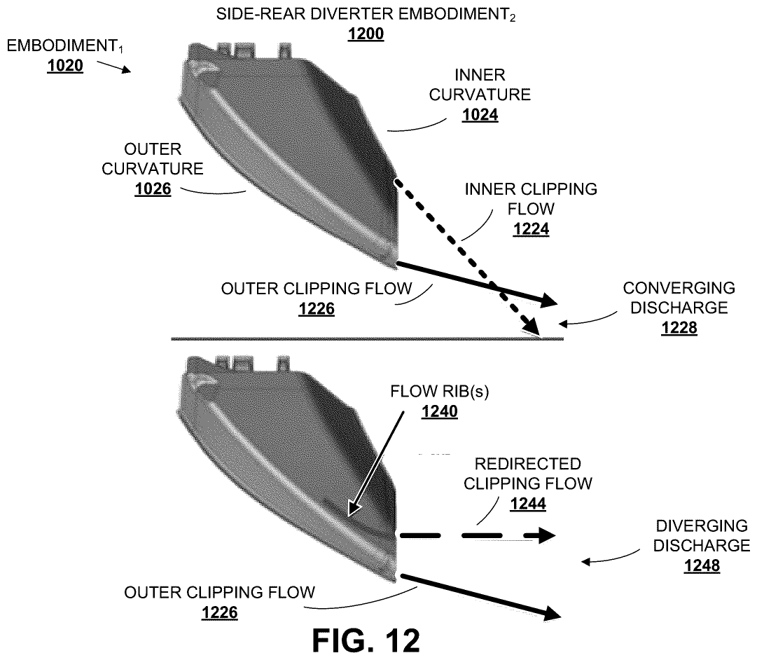

A second embodiment: embodiment₂ 1020 is shown on the right side of FIG. 10 having a second discharge attachment 1022. Further, embodiment₂ 1020 can define a second inner curvature 1024 surface and a second outer curvature 1026 surface which direct clippings ejected from an attached mowing device at an ejection input surface adjacent second discharge attachment 1022 to a second ejection output 1028 (see also FIG. 12, infra). More specifically, embodiment₂ 1020 can receive clippings ejected (primarily) in a first direction (or range of directions) rearward from the attached mowing device and direct the received clippings into a second direction (or range of directions) sideways and lateral to the attached mowing device.

FIG. 11 includes a diagram 1100 of output clipping flow for embodiment₁ 1010 of alternate side-rear diverters 1000. Clipping flow received into embodiment₁ 1010 is directed in part by inner curvature 1014 to an inner clipping flow 1114 at ejection output 1018 and in further part outer curvature 1016 to an outer clipping flow 1116 at ejection output 1018. A default clipping output is a converging discharge 1118 as shown in FIG. 11. The converging discharge 1118 can be less than optimal as it can encourage clumped clippings on top of turf that do not readily settle to an underlying surface of the turf. This can result in an unsightly turf distribution. To improve clipping output, one or more flow ribs 1130 can be formed adjacent ejection output 1018 to form redirected clipping flow 1134 that, together with outer clipping flow 1116, generates a diverging discharge 1138. Diverging discharge can minimize clumping of turf clippings on top of the turf, and maximize distribution of clippings and settling of the clippings to the underlying surface below the top of the turf. This can improve aesthetic appearances of clipping output on the turf surface.

FIG. 12 includes a diagram 1200 of output clipping flow for embodiment₂ 1020 of alternate side-rear diverters 1000. Clipping flow received into embodiment₂ 1020 is directed in part by inner curvature 1024 to an inner clipping flow 1224 at ejection output 1028 and in further part outer curvature 1026 to an outer clipping flow 1226 at ejection output 1028. The result of inner clipping flow 1224 and outer clipping flow 1226 is a converging discharge 1228 as shown in FIG. 12. As mentioned previously, converging discharge 1228 can result in clumped-up clippings lingering on top of turf that resist settling below the turf to the ground below. This can result in an unsightly turf distribution. To improve clipping output, one or more flow ribs 1240 can be formed adjacent ejection output 1028 to form redirected clipping flow 1244 that, together with outer clipping flow 1226, generates a diverging discharge 1248. Diverging discharge 1248 can broadly distribute turf clippings and maximize spread and settling of the clippings to the underlying surface below the top of the turf. This can improve aesthetic appearance of clipping output on the turf surface.

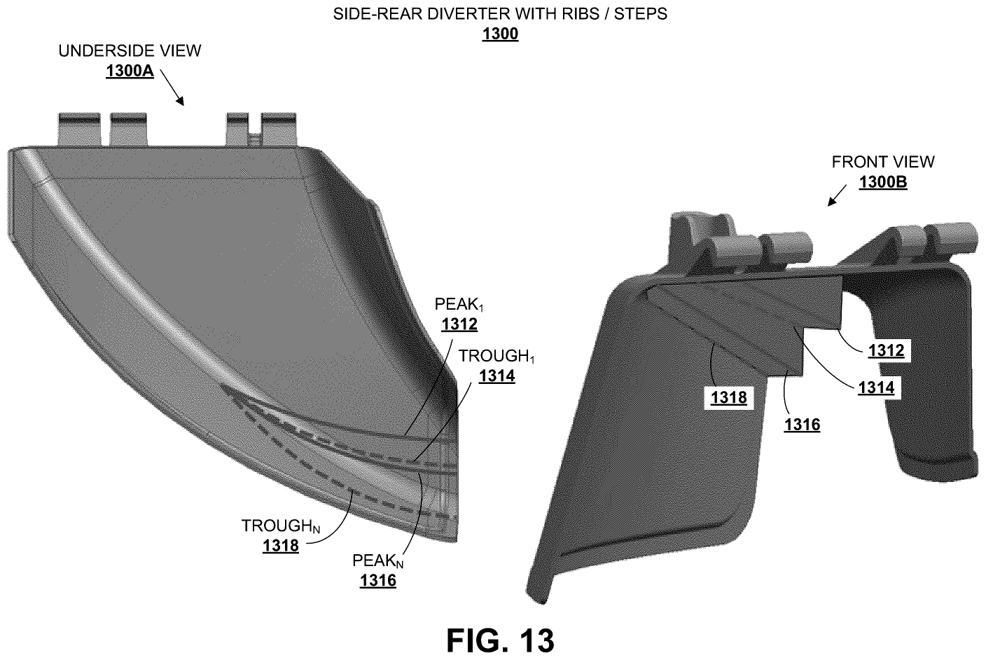

FIG. 13 depicts an alternate side-rear diverter 1300 according to alternative or additional embodiments of the present disclosure. Alternate side-rear diverter 1300 replaces relatively thin flow rib(s) with steps or protrusions formed within an interior upper surface of alternate side-rear diverter 1300 to direct flow of clippings out an output portion thereof.

FIG. 13 shows an underside view 1300A of alternate side-rear diverter 1300. The example of alternate side-rear diverter 1300 depicted includes multiple steps, protrusions or the like defining a first protrusion peak₁ 1312 and first protrusion trough₁ 314, through an N^{th} protrusion peak_{N} 1316 and an N^{th} protrusion trough_{N} 1318, where N is an integer greater than zero. Thus, in some embodiments alternate side-rear diverter 1300 can have a single protrusion, and in further embodiments can have multiple protrusions. FIG. 13 also illustrates a front view 1300B of alternate side-rear diverter 1300 looking into a discharge entrance beneath a discharge attachment. Protrusion peak₁ 1312 and protrusion trough₁ 1314 of a first step/protrusion is visible adjacent an upper interior surface of alternate side-rear diverter 1300, and protrusion peak_{N} 1316 and protrusion trough_{N} 1318 of an N^{th} step/protrusion is visible near the upper interior surface and interior surface of outer curvature 1016, for instance.

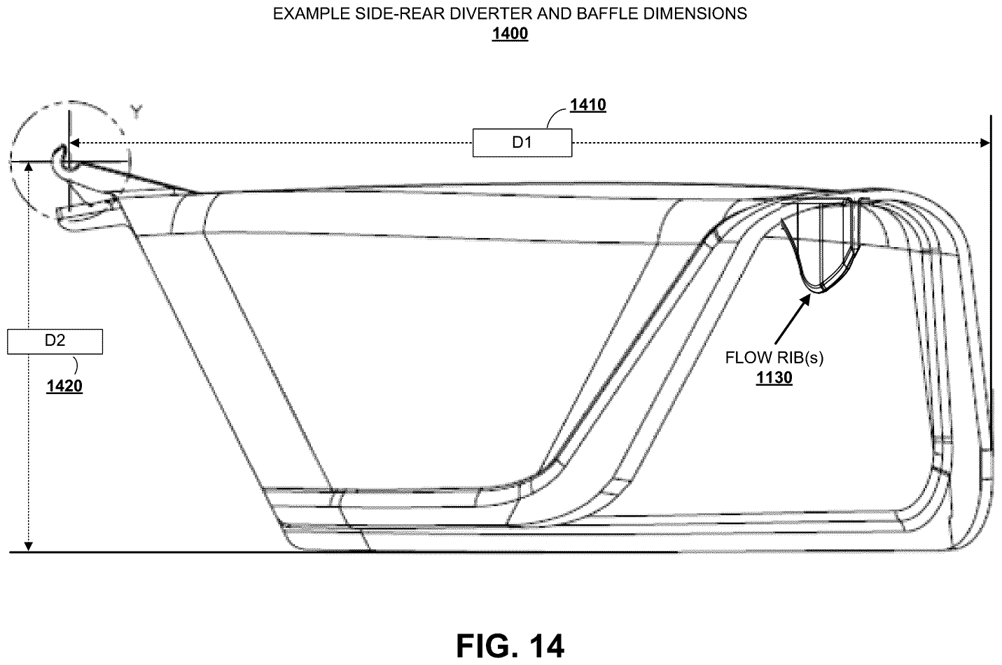

FIG. 14 illustrates an example line drawing of a side view of a discharge output of embodiment₁ 1010. Flow rib(s) 1130 is depicted at an interior upper surface of embodiment₁ 1010. Dimensions D1 1410 and D2 1420 define a length and height, respectively, of embodiment₁ 1010. Length dimension D1 1410 can be between about 10 inches and about 16 inches, in various embodiments; between 12 inches and 15 inches in further embodiments; about 13, 13.25, 13.5, 13.75, 14 inches in still other embodiments, or suitable values or ranges between any of the foregoing. Height dimension D2 1420 can be between about 4 inches and about 7 inches in further embodiments; between about 5 inches and about 6 inches in additional embodiments; about 5.0, 5.2, 5.4, 5.6, 5.8 or 6.0 inches in still other embodiments, or suitable values or ranges between any of the foregoing.

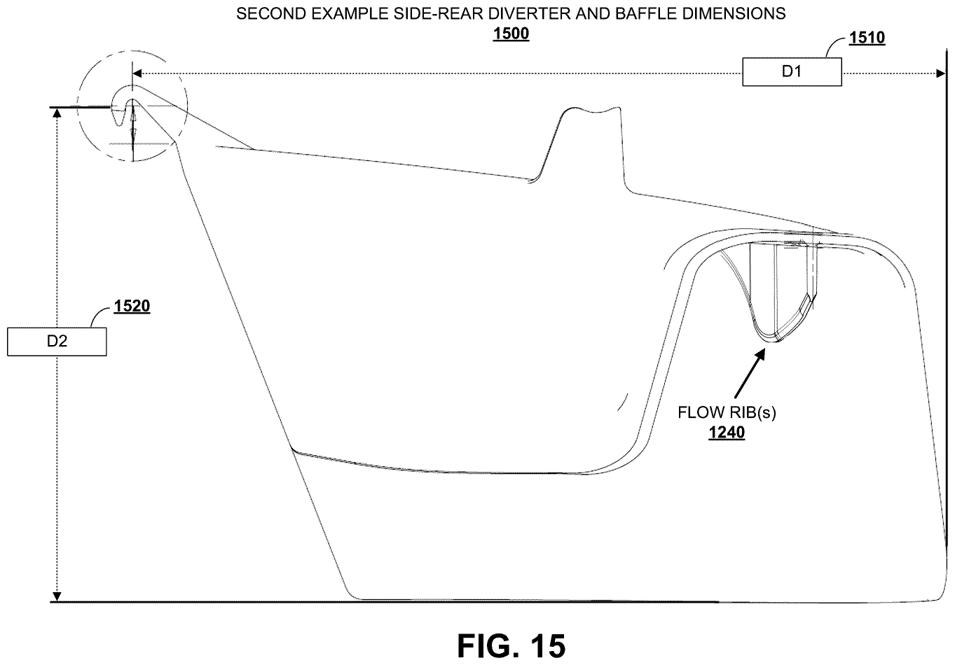

FIG. 15 illustrates an example line drawing of a side view of a discharge output of embodiment₂ 1020. Flow rib(s) 1240 is depicted at an interior upper surface of embodiment₂ 1020. Dimensions D1 1510 and D2 1520 define a length and height, respectively, of embodiment₂ 1020. Length dimension D1 1510 can be between about 10 inches and about 16 inches, in various embodiments; between 12 inches and 15 inches in further embodiments; about 13, 13.25, 13.5, 13.75, 14 inches in still other embodiments, or suitable values or ranges between any of the foregoing. Height dimension D2 1420 can be between about 6 inches and about 10 inches in further embodiments; between about 8 inches and about 9 inches in additional embodiments; about 8.0, 8.2, 8.4, 8.6, 8.8 or 6.0 inches in still other embodiments, or suitable values or ranges between any of the foregoing.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A discharge chute for a mowing apparatus, comprising:
a housing defining:
an inlet having an inlet perimeter in fluid communication with at least a portion of a discharge opening of a mow deck of the mowing apparatus, the inlet adapted to receive discharge material from the discharge opening of the mow deck,
an outlet adapted to direct the discharge material away from the discharge chute and from the mowing apparatus, and
a surface connecting the inlet with the outlet and directing the discharge material received from the discharge opening of the mow deck into an exit direction that is different from an entrance direction of the discharge material as received at the inlet of the housing from the mow deck; and
a one or more baffles protruding downward from a top surface of the housing into an interior volume of the discharge chute, wherein the top surface is adjacent the surface, and wherein the set of baffles is adapted to separate a flow of the discharge material at the outlet into at least a first flow path and a second flow path.

2. The mower discharge chute of claim 1, wherein the one or more baffles are adapted to spatially separate the first flow path from the second flow path along a width of the outlet during operation of the mowing apparatus.

3. The mower discharge chute of claim 1, wherein the one or more baffles comprises at least two baffles.

4. The mower discharge chute of claim 3, wherein the one or more baffles are adapted to separate the flow of the discharge material at the outlet into at least the first flow path, the second flow path and a third flow path.

5. The mower discharge chute of claim 4, wherein the first flow path, the second flow path and the third flow path are adapted to disperse the discharge material along a width of the outlet during operation of the mowing apparatus.

6. The mower discharge chute of claim 5, wherein the first flow path is bounded by the surface connecting the inlet with the outlet and bounded by a first baffle of the at least two baffles, and wherein the first flow path comprises a largest portion of the discharge material compared with the second flow path and the third flow path.

7. The mower discharge chute of claim 1, further comprising an interior surface connecting the inlet with the outlet and on an opposite side of the housing from the surface, wherein a distance along the outlet between the surface and the interior surface defines a width of the outlet.

8. The mower discharge chute of claim 7, wherein a first baffle of the one or more baffles is a first distance from the interior surface along the width of the outlet, wherein the first distance is about one-quarter to one-third of the width of the outlet.

9. The mower discharge chute of claim 8, wherein a second baffle of the one or more baffles is a second distance from the interior surface along the width of the outlet, wherein the second distance is about one-half of the width of the outlet.

10. The mower discharge chute of claim 8, wherein the first baffle extends a third distance from about 1.5 inches (in.) to about 2.5 in. below the top surface into the interior volume of the discharge chute, and wherein the second baffle extends a fourth distance from about 1.5 in. to about 2 in. below the top surface into the interior volume of the discharge chute.

11. The mower discharge chute of claim 7, wherein the one or more baffles extend from an edge of the outlet on the top surface to a depth of about 3 in. to about 4 in. into the housing.

12. A mowing apparatus, comprising
a mow deck defining:
a housing having an interior space adapted to accommodate motion of a blade apparatus that is secured to the housing, and
an ejection opening defined within a portion of an interior wall of the housing;
a discharge body secured to the mow deck and having a chute interior in fluid communication with the ejection opening of the mow deck at a first end of the chute interior; and
a discharge chute removably inserted into a second end of the chute interior of the discharge body wherein the discharge chute comprises:
an inlet that receives discharge material exiting the mow deck from the ejection opening,
an outlet that directs the discharge material away from the mowing apparatus, and
a set of aerodynamically functional baffles formed within an interior space of the discharge chute near the outlet and adapted to separate a flow of the discharge material into a plurality of flow paths including at least a first flow path and a second flow path.

13. The mowing apparatus of claim 12, wherein the ejection opening is defined with a rear half of the housing of the mow deck and the discharge material is expelled rearward from the mow deck through the ejection opening.

14. The mowing apparatus of claim 13, wherein the discharge chute defines a surface that connects the inlet and the outlet along a curvature that redirects the discharge material from the rearward direction with respect to the mow deck to a sideward direction away from the mowing apparatus.

15. The mowing apparatus of claim 14, wherein:
the discharge chute defines an interior surface that connects the inlet and the outlet at an opposite side of the discharge chute from the surface; and
the set of aerodynamically functional baffles includes a first baffle that directs discharge material between the interior surface and the first baffle into the first flow path.

16. The mowing apparatus of claim 15, wherein the set of aerodynamically functional baffles includes a second baffle between the first baffle and the surface that directs discharge material between the first baffle and the second baffle into the second flow path.

17. The mowing apparatus of claim 16, wherein discharge material between the second baffle and the surface is directed by the discharge chute into a third flow path of the plurality of flow paths.

18. The mowing apparatus of claim 15, wherein the set of aerodynamically functional baffles includes an additional curvature defined along the interior surface that directs discharge material along the additional curvature into a side wall of the first baffle and into the first flow path.

19. The mowing apparatus of claim 15, wherein the first baffle is between about one quarter and about one third a distance between the interior surface and the surface along the outlet of the discharge chute, and wherein a second baffle of the set of aerodynamically functional baffles includes about one half the distance between the interior surface and the surface along the outlet.

20. The mowing apparatus of claim 19, wherein the set of aerodynamically functional baffles extend from a top surface of the discharge chute that is between the surface and the interior surface into an inner volume of the discharge chute, wherein the first baffle extends a first distance into the inner volume from the top surface and the second baffle extends a second distance into the inner volume from the top surface, and wherein the first distance is larger than the second distance.
